(19) United States
(12) Patent Application Publication
(10) Pub. No.: US 2017/0076335 A1
(43) Pub. Date: Mar. 16, 2017

(54) BIG DATA ENABLED INSIGHTS BASED PERSONALIZED 3D OFFERS

(71) Applicant: International Business Machines Corporation, Armonk, NY (US)

(72) Inventors: Michael E. Alexander, Great Falls, VA (US); William M. Duckworth, Sydney (AU); Shantanu H. Ghosh, Maharashtra (IN); Jigneshkumar K. Karia, Maharashtra (IN); Gandi Sivakumar, Victoria (AU)

(21) Appl. No.: 14/854,969

(22) Filed: Sep. 15, 2015

(51) Int. Cl. G06Q 30/02; G06T 19/20; G06Q 50/00

(52) U.S. Cl. CPC G06Q 30/0269; G06Q 50/01; G06T 19/20

(57) ABSTRACT

A method, system and computer program product are disclosed for preparing and sending personalized offers to consumers. In an embodiment, the method comprises extracting information from data sources to obtain information about a consumer, including information to determine specified consumer preferences; and using the information about the consumer to generate customized suggestions for wearable apparel types for the consumer, and to produce consumer specific apparel data to show the wearable apparel types fitted onto a 3D photographic representation of the consumer. The method also comprises sending the customized suggestions to a user device; and including with the suggestions a link to the consumer specific apparel data to enable the consumer to operate the consumer specific apparel data to show on the user device the suggested apparel types fitted onto the 3D photographic representation of the consumer with one or more of the specified consumer preferences.

### BACKGROUND

This invention generally relates to preparing and sending personalized offers to consumers. Embodiments of the invention relate to preparing and sending personalized offers based on insights obtained from information extracted from various sources of data.

Many industries are shifting to what is referred to as big insight based actions, which is to use insight obtained from large collections of data to determine how to take specific actions. This encompasses collecting data from various sources including external channels like social media, networks, or others, and internal data sources like call center records, customer profiles, etc. There are also commercial enterprises that provide such data to be used for various purposes.

Once the insights are known, the actions can be aligned to suit the preferences, likes and dislikes of customers. Examples of actions would be pushing advertisements through near real time or delayed campaigns, and handling call center inquiries in a better manner, etc.

Various industries promote advertisements through soft and hard media. One such industry is the apparel industry, where promotions are general and often lack in dynamically varying aspects. Some promotions may enable catalogues blending with big data but lack in dynamically varying elements.

### SUMMARY

Embodiments of the invention provide a method, system and computer program product for preparing and sending personalized offers to consumers. In an embodiment, the method comprises extracting information from a plurality of data sources to obtain information about a consumer, including information to determine a plurality of specified consumer preferences; obtaining data to generate a 3D photographic representation of the consumer; and using said information about the consumer to generate customized suggestions for wearable apparel types for the consumer, and to produce consumer specific apparel data to show the wearable apparel types fitted onto the 3D photographic representation of the consumer. The method also comprises sending the customized suggestions to a user device to show the suggestions to the consumer; and including with said suggestions a link to the consumer specific apparel data to enable the consumer to operate the consumer specific apparel data to show on the user device the suggested apparel types fitted onto the 3D photographic representation of the consumer with one or more of the specified consumer preferences.

In embodiments of the invention, the including with said suggestions a link to the consumer specific apparel data includes providing with said suggestions sales promotions to promote sales of apparel to the consumer.

In an embodiment, the extracting information from a plurality of data sources to obtain information about a consumer includes storing the extracted information in an insights based database, and using the insights based database to identify the specified consumer preferences.

In one embodiment, said plurality of data sources includes at least one defined social media platform.

In an embodiment, the extracted information includes one or more statements made by the consumer on said at least one defined social media platform.

In embodiments of the invention, the using the consumer information to generate customized suggestions for the consumer includes using a fitment suggestions algorithm to generate the suggestions using 3D fitment and availability of garments for a particular fit and body type determined from the 3D photographic representation of the consumer.

In an embodiment, the using the consumer information to generate customized suggestions for the consumer includes using a personalized suggestions algorithm to generate the suggestions for apparel type based on defined social media data about the consumer.

In embodiments of the invention, the 3D photographic representation of the consumer is a photograph of the consumer.

In one embodiment, the obtaining data to generate a 3D photographic representation of the user includes receiving said data from the consumer.

In an embodiment, the sending the customized suggestions to the user device includes selecting one of a plurality of given types of media to send the customized suggestions to the user.

Embodiments of the invention provide a system for preparing and sending personalized offers to consumers. In an embodiment, the system comprises a database, a crawler processing unit, a data server and a sending processing unit. In an embodiment, the crawler processing unit extract information about consumers from a plurality of data sources, including information to determine a plurality of specified consumer preferences for each of the consumers, and stores the extracted information in the database. The data server receives image data to generate 3D photographic representations of the consumers, and uses the image data and the information in the database to generate for each of the consumers customized suggestions for wearable apparel types, and produces consumer specific apparel data for each of the consumers to show the suggested wearable apparel types for said each consumer fitted onto the 3D photographic representation of said each consumer. The sending processing unit sends the customized suggestions to user devices to show the customized suggestions to the consumers, and includes with said suggestions links to the consumer specific apparel data to enable each of the consumers to operate the consumer specific apparel data produced for said each consumer to show on one of the user devices the suggested wearable apparel types for said each consumer fitted onto the 3D photographic representation of said each consumer with one or more of the specified consumer preferences.

In an embodiment, the sending processing unit includes with said suggestions sales promotions to promote sales of the apparel to the consumers.

In one embodiment, the data server includes a fitment suggestions algorithm to generate the suggestions using 3D fitment and availability of garments for particular fit and body types determined from the 3D photographic representations of the consumers.

In an embodiment, the data server includes a personalized suggestions algorithm to generate the suggestions for apparel type based on defined social media data about the consumers.

In embodiments, the information extracted by the crawler processing unit includes statements made by the consumers on at least one defined social media platform, and the data server uses said statements to generate said customized suggestions.

Embodiments of the invention provide a computer implemented method where a consumer is presented with promotions for matching garments based on the output of a 3D photo fitment algorithm and the output of a data base dynamic algorithm. The data based dynamic algorithm uses the insights database which hosts multiple parameters of customer profile data (age, gender, color preferences, past buys, planned travel, etc.) and social media based context to generate targeted and context aware promotions of best fitting garments along with discount information.

Embodiments of the invention send out personalized 3D photo promotions to a customer with a link to matching apparels based on the customer's profile, social networking insights, and also based on the customer's fitment along with discounts from various vendors. The link, when opened, shows the apparel on the customer's 3D avatar so that the customer can choose his or her preferred apparel without having to visit the apparel site or store.

Currently, during on-line shopping, consumers have to search and browse through websites to find out the availability of garments which fit and are as per their choice. Apparel sizes and fits are non-standardized, however, making standard on-line layover techniques inaccurate. Hence, on-line apparel purchases involve uncertainty with regards to size and fit, and therefore result in a large number of returns. The consumers have to visit the store personally to see how particular apparel fit their personalities.

### BRIEF DESCRIPTION OF THE DRAWINGS

FIG. 1 illustrates a system for preparing and sending personalized offers to consumers in accordance with an embodiment of the invention.

FIG. 2 shows a part of an algorithm for preparing and sending personalized offers to consumers in accordance with an embodiment of the invention.

FIG. 3 shows an additional part of the algorithm for preparing and sending personalized offers to consumers.

FIG. 4 illustrates a computing system that may be used in embodiments of the invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

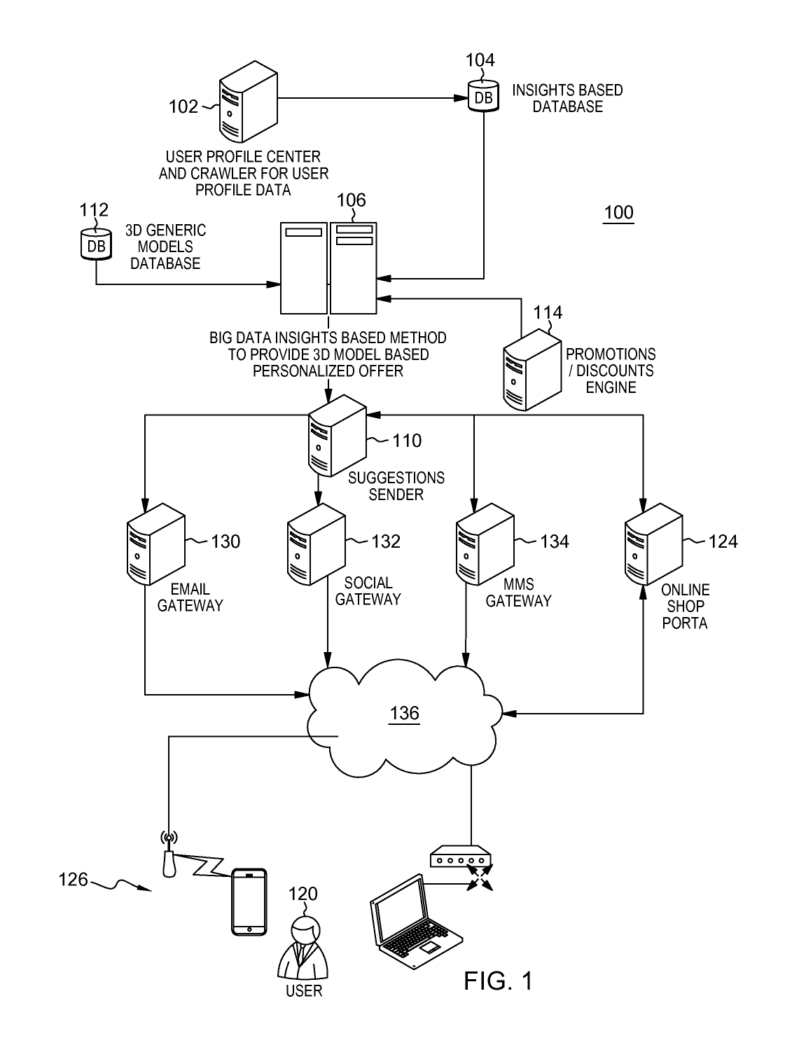

This invention generally relates to preparing and sending personalized offers to consumers. Embodiments of the invention relate to preparing and sending personalized offers based on insights obtained from information extracted from various sources of data. FIG. 1 illustrates a system 100 in accordance with an embodiment of the invention. System 100, generally, comprises a back-end crawler 102, database 104, data server 106, and sender 110; and with the embodiment shown in FIG. 1, system 100 also includes a 3D generic models database and promotions/discounts engine 114. FIG. 1 further illustrates a user or consumer 120, user devices 122, and on-line shopping portal 124. FIG. 1 also shows a plurality of media servers, including e-mail gateway 130, social media gateway 132, and a multi-media messaging system gateway 134, and a distributed network 136 such as the Internet.

Generally, in the operation of system 100, crawler 102 extracts information about consumers from a plurality of data sources, including information to determine a plurality of specified consumer preferences for each of the consumers, and the crawler 102 stores the information in the database 104. Data server 106 receives image data to generate 3D photographic representations of the consumers, and to use the image data and the information in the database 104 to generate for each of the consumers customized suggestions for wearable apparel types. Data server 106 also produces consumer specific apparel data for each of the consumers to show the suggested wearable apparel types for said each consumer fitted onto the 3D photographic representation of said each consumer.

Sending unit 110 sends the customized suggestions to user devices 122, via network 136, to show the customized suggestions to the consumers, and the sending unit also includes with these suggestions links to the consumer specific apparel data. These links enable each of the consumers to operate the consumer specific apparel data produced for that consumer to show on one of the user devices the suggested wearable apparel types for said each consumer fitted onto the 3D photographic representation of that consumer with one or more of the specified consumer preferences.

Embodiments of the invention may be used with a wide range of data types and data sources. As discussed in more detail below, embodiments of the invention are well suited for use with data described as Big Data. Big Data, generally, refers to both structured and unstructured data that are available in high volumes, including data that is streaming at a high speed, and comes in a wide range of formats.

Big Data includes unstructured data streaming in from social media, data collected from sensors and machine-to-machine data, and data from RFID tags and smart meters. Big Data also includes structured, numeric data in traditional data bases, information created from line-of-business applications, unstructured text documents, email, video, audio, and financial transactions.

As shown in FIG. 1, data server 106 is in communication with user devices 122 via distributed network 136, which in an embodiment of the invention is the Internet. The Internet is a worldwide collection of computer networks and gateways that use the TCP/IP suite of protocols to communicate with one another. At the core of the Internet is a backbone of high speed data communication lines between major nodes or host computers comprised of thousands of commercial, government, education, and other computer systems that route data and messages. The present invention, it may be noted, may be implemented with a number of different types of distributed networks, such as, for example, an intranet, a local area network (LAN) or a wide area network (WAN), and the invention may be used with other protocols besides TCP (e.g., UDP, RTP, IP-in-IP (tunneling) etc.). The Internet shown in FIG. 1 is intended as an example of a distributed network and not as a limitation of the present invention.

Any suitable user devices 122 may be used in embodiments of the invention. Generally, these devices are able to send data to and receive data from distributed network 136, and the user devices are able to process and display data. The user devices may be connected to network 136 via a wireless or wired connection. User devices 122 shown in FIG. 1 are representative of any appropriate type of device that includes a computing device, such as a laptop, a personal digital assistant (“PDA”), a portable phone, such as a cell phone or the like, a smart phone, a Session Initiation Protocol (SIP) phone, a video phone, a portable email device, a thin client, a portable gaming device, etc. Devices 122 may also be, as additional examples, tablet computers and single-purpose mobile devices (such as eBooks).

Embodiments of the invention use techniques or procedures described as 3D photo-imaging or 3D photographs. A 3D photo is a photo or image, typically shown on a display screen, that can be manipulated so that a person or object in the photo appears to rotate or move relative to the viewer, allowing a view of that person or object from a number of angles or views. The apparent rotation of movement of the person or object may be slight or substantial, depending on the image data and the software being used. For instance, software applications are well-known and available that allow views over a 360° range and at numerous angles.

Further, in embodiments of the invention, database 104 is described as an insights database, which is a database designed to model, analyze and visualize data in real time.

In embodiments of the invention, a user 120 creates a profile. This profile may include any suitable or appropriate information about the user, such as height, weight and age. The profile may be input to or stored on a variety of devices or places, such as a mobile communications device, a social media site, or a personal computer.

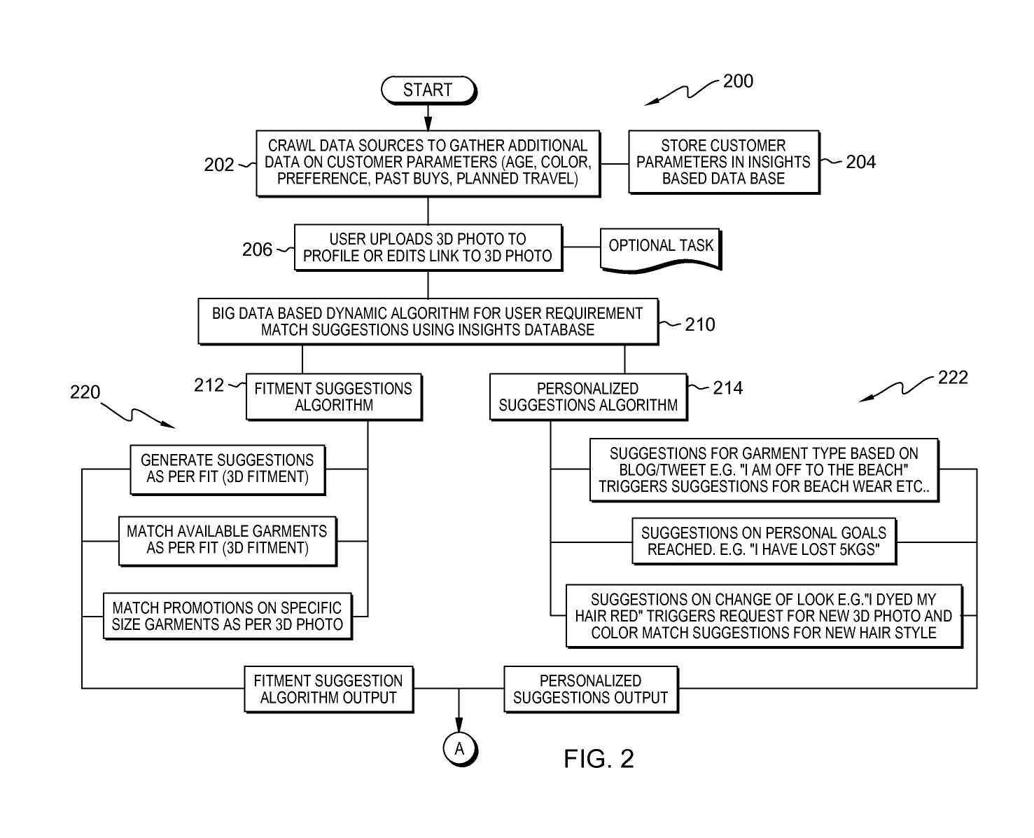

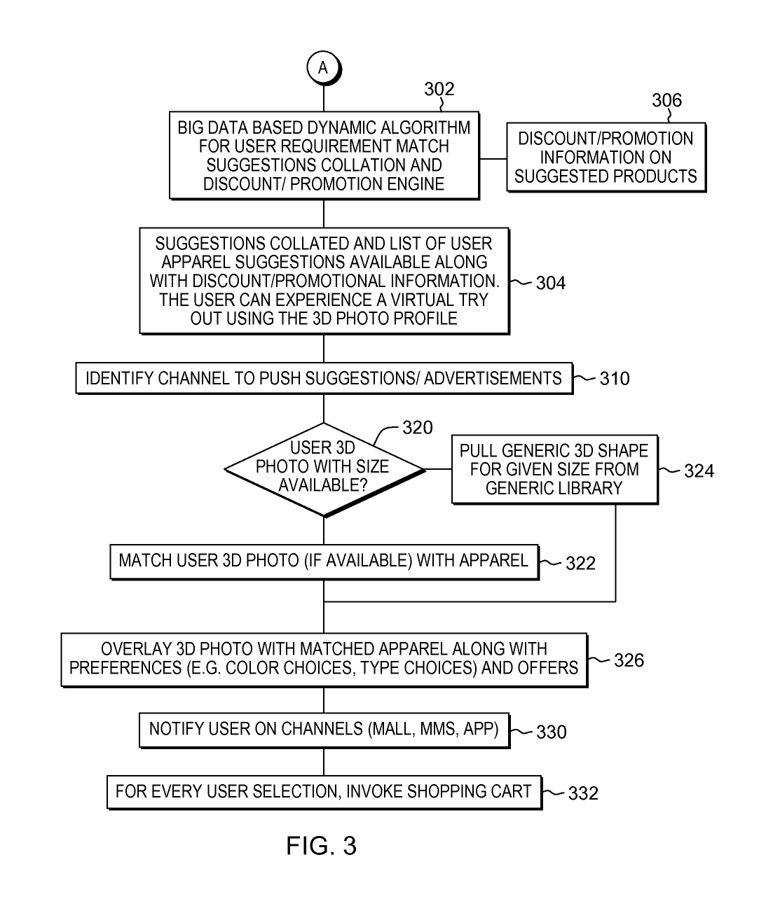

FIGS. 2 and 3 show an algorithm for implementing an embodiment of the invention.

At 202, a back-end processor 102 crawls a plurality of data sources to gather additional data on user parameters (age, color preferences, past buys, planned travel, a wish list, etc.). These data sources may include social media platforms. The crawler may look through a wide range of places or devices for this additional information. At 204, the user parameters are stored in insights based database 104.

As represented at 206, optionally the user can choose to upload a 3D photo or post a link to the 3D photo. If a 3D photo of the user is not available, system 100 may pick up a suitable default 3D photo from, for example, data base 112.

At 210, data based dynamic algorithms for user requirement match apparel are used to create suggestions for the user using insights database. In embodiments of the invention, two specific types of algorithms are used: a fitment suggestions algorithm 212, and a personalized suggestions algorithm 214.

The fitment suggestions algorithm, at 220, generates suggestions for fitting garments to the user using 3D fitment and availability of garments for a particular fit and body type as shown in the 3D photo. If a 3D photo is not available, the algorithm may use a pre-set generic 3D model of the body type for fitment.

In embodiments of the invention, the personalized suggestions algorithm, at 222, generates suggestions for apparel type based on social media data. For example, social media jottings such as a blog or tweet, e.g., “I am off to the beach,” triggers suggestions for beach wear. Data on personal goals reached, e.g., “I have lost 5 kgs,” may trigger suggestions on apparel which can be a tighter fit, or trigger a request for a new 3D photo. Data on change of looks, e.g., “I dyed my hair red,” can trigger suggestions for a new hair style.

At 302 and 304, the data based dynamic algorithm collates the suggestions from the previous algorithms and matches those suggestions with the available apparel data. The data based dynamic algorithm, at 306, also adds the discount/promotion information for the matched apparel. These discounts and promotions may come from promotions/discounts engine 114

Solution server 110, at 310, identifies the channel to use to push the suggestions/advertisement to the user. A wide range of channels may be used in embodiments of the invention. For instance, the user may be notified of the suggestion/advertisement via e-mail, a multi-media messaging service, a social website, or a specified application. Other channels may also be used.

On receiving the suggestions, the user, as represented at 320, 322 and 324, can virtually try out the suggested apparel using his or her 3D photo profile, if available, or using a generic 3D body shape from the library for a given body type and size. During the virtual try out, at 326, the user's 3D photo is overlaid with the suggested apparel along with the preferences (color and type choices).

Offers including promotions and discounts may be shown to the user during the virtual try out. These offers may be flashed to the user. The offers may be shown in other ways also; and for example, the offers may be shown continuously or for extended periods of time.

In embodiments of the invention, as represented at 330, system 100 has the ability to push the offers over various channels to various types of devices such as mobile phones, tablets, laptop computers and others.

As indicated at 332, for every user selection, the selected apparel is placed in the shopping cart.

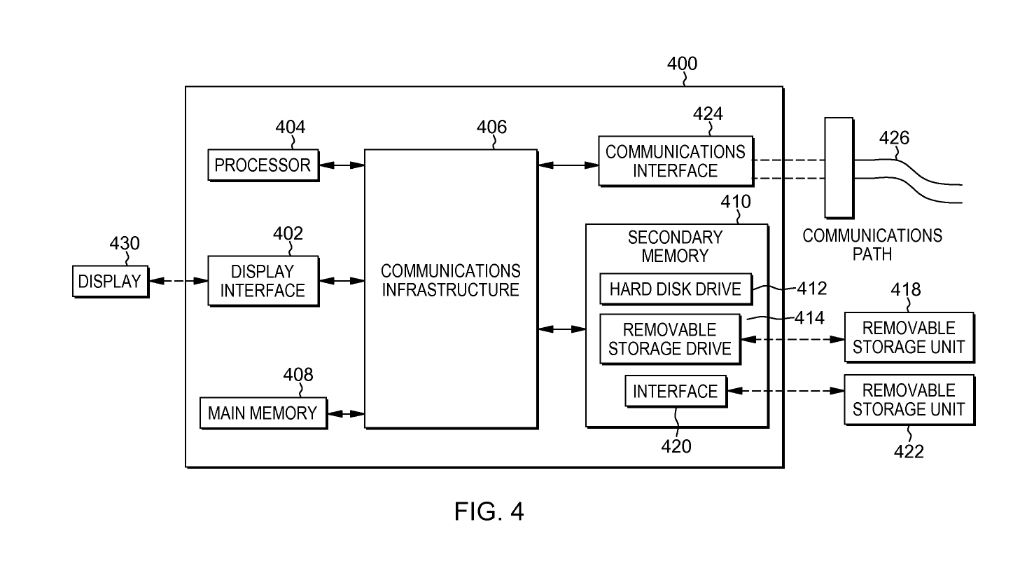

As will be apparent to those of ordinary skill in the art, any suitable processors, computers and servers may be used in embodiments of the invention, and FIG. 4 illustrates a computer system 400 in which embodiments of the present disclosure, or portions thereof, may be implemented. For example, the processing units 102 and 110 and the server 106 of FIG. 1 may be implemented in the computer system 400. A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit, and a hard disk installed in a hard disk drive.

Processor device 404 may be a special purpose or a general purpose processor device. The processor device 404 may be connected to a communications infrastructure 406, such as a bus, message queue, network, multi-core message-passing scheme, etc. The network may be any suitable network and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 408 (e.g., random access memory, read-only memory, etc.), and may also include a secondary memory 410. The secondary memory 410 may include the hard disk drive 412 and a removable storage drive 414, such as a floppy disk drive, a magnetic tape drive, an optical disk drive, a flash memory, etc.

The removable storage drive 414 may read from and/or write to the removable storage unit 418 in a well-known manner. The removable storage unit 418 may include a removable storage media that may be read by and written to by the removable storage drive 414. Data stored in the computer system 400 (e.g., in the main memory 608 and/or the secondary memory 410) may be stored on any type of suitable computer readable media, such as optical storage (e.g., a compact disc, digital versatile disc, Blu-ray disc, etc.) or magnetic tape storage (e.g., a hard disk drive).

The computer system 400 may also include a communications interface 424 configured to allow software and data to be transferred between the computer system 400 and external devices. Exemplary communications interfaces 424 may include a modem, a network interface (e.g., an Ethernet card), a communications port, a PCMCIA slot and card, etc.

Computer program medium and computer usable medium may refer to memories, such as the main memory 408 and secondary memory 410, which may be memory semiconductors (e.g., DRAMs, etc.). These computer program products may be means for providing software to the computer system 400. Computer programs (e.g., computer control logic) may be stored in the main memory 608 and/or the secondary memory 410.

Those of ordinary skill in the art will appreciate that the hardware depicted in FIG. 4 may vary. The depicted example is not meant to imply architectural limitations with respect to the present invention.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of preparing and sending personalized offers to consumers, comprising:
extracting information from a plurality of data sources to obtain information about a consumer, including information to determine a plurality of specified consumer preferences;
obtaining data to generate a 3D photographic representation of the consumer;
using said consumer information to generate customized suggestions for wearable apparel types for the consumer, and to produce consumer specific apparel data to show the wearable apparel types fitted onto the 3D photographic representation of the consumer;
sending the customized suggestions to a user device to show the suggestions to the consumer; and
including with said suggestions a link to the consumer specific apparel data to enable the consumer to operate the consumer specific apparel data to show on the user device the suggested apparel types fitted onto the 3D photographic representation of the consumer with one or more of the specified consumer preferences.

2. The method according to claim 1, wherein the including with said suggestions a link to the consumer specific apparel data includes providing with said suggestions sales promotions to promote sales of apparel to the consumer.

3. The method according to claim 1, wherein the extracting information from a plurality of data sources to obtain information about a consumer includes:
storing the extracted information in an insights based database; and
using the insights based database to identify the specified consumer preferences.

4. The method according to claim 1, wherein said plurality of data sources includes at least one defined social media platform.

5. The method according to claim 4, wherein the extracted information includes one or more statements made by the consumer on said at least one defined social media platform.

6. The method according to claim 1, wherein the using the consumer information to generate customized suggestions for the consumer includes using a fitment suggestions algorithm to generate the suggestions using 3D fitment and availability of garments for a particular fit and body type determined from the 3D photographic representation of the consumer.

7. The method according to claim 1, wherein the using the consumer information to generate customized suggestions for the consumer includes using a personalized suggestions algorithm to generate the suggestions for apparel type based on defined social media data about the consumer.

8. The method according to claim 1, wherein the 3D photographic representation of the consumer is a photograph of the consumer.

9. The method according to claim 1, wherein the obtaining data to generate a 3D photographic representation of the user includes receiving said data from the consumer.

10. The method according to claim 1, wherein the sending the customized suggestions to the user device includes selecting one of a plurality of given types of media to send the customized suggestions to the user.

11. A system for preparing and sending personalized offers to consumers, comprising:
a database;
a crawler processing unit to extract information about consumers from a plurality of data sources, including information to determine a plurality of specified consumer preferences for each of the consumers, and to store the information in the database;
a data server to receive image data to generate 3D photographic representations of the consumers, and to use the image data and the information in the database to generate for each of the consumers customized suggestions for wearable apparel types, and to produce consumer specific apparel data for each of the consumers to show the suggested wearable apparel types for said each consumer fitted onto the 3D photographic representation of said each consumer; and
a sending processing unit to send the customized suggestions to user devices to show the customized suggestions to the consumers, and to include with said suggestions links to the consumer specific apparel data to enable each of the consumers to operate the consumer specific apparel data produced for said each consumer to show on one of the user devices the suggested wearable apparel types for said each consumer fitted onto the 3D photographic representation of said each consumer with one or more of the specified consumer preferences.

12. The system according to claim 11, wherein the sending processing unit includes with said suggestions sales promotions to promote sales of the apparel to the consumers.

13. The system according to claim 11, wherein the data server includes a fitment suggestions algorithm to generate the suggestions using 3D fitment and availability of garments for particular fit and body types determined from the 3D photographic representations of the consumers.

14. The system according to claim 11, wherein the data server includes a personalized suggestions algorithm to generate the suggestions for apparel type based on defined social media data about the consumers.

15. The system according to claim 11, wherein:
the information extracted by the crawler processing unit includes statements made by the consumers on at least one defined social media platform; and
the data server uses said statements to generate said customized suggestions.

16. An article of manufacture comprising:
at least one tangible computer readable medium having computer readable program code logic to prepare and send personalized offers to consumers, the computer readable program code logic, when executing, performing the following:
extracting information from a plurality of data sources to obtain information about a consumer, including information to determine a plurality of specified consumer preferences;
obtaining data to generate a 3D photographic representation of the consumer;
using said consumer information to generate customized suggestions for wearable apparel types for the consumer, and to produce consumer specific apparel data to show the wearable apparel types fitted onto the 3D photographic representation of the consumer;
sending the customized suggestions to a user device to show the suggestions to the consumer; and
including with said suggestions a link to the consumer specific apparel data to enable the consumer to operate the consumer specific apparel data to show on the user device the suggested apparel types fitted onto the 3D photographic representation of the consumer with one or more of the specified consumer preferences.

17. The article of manufacture according to claim 16, wherein the including with said suggestions a link to the consumer specific apparel data includes providing sales promotions with said suggestions to promote sales of apparel to the consumer.

18. The article of manufacture according to claim 16, wherein the extracting information from a plurality of data sources to obtain information about a consumer includes:
storing the extracted information in an insights based database; and
using the insights based database to identify the specified consumer preferences.

19. The article of manufacture according to claim 16, wherein:
said plurality of data sources includes at least one defined social media platform; and
the extracted information includes one or more statements made by the consumer on said at least one defined social media platform.

20. The article of manufacture according to claim 1, wherein the using the consumer information to generate customized suggestions for the consumer includes:
using a fitment suggestions algorithm to generate the suggestions using 3D fitment and availability of garments for a particular fit and body type determined from the 3D photographic representation of the consumer; and
using a personalized suggestions algorithm to generate the suggestions for apparel type based on defined social media data about the consumer.
